(19) United States
(12) Patent Application Publication
(10) Pub. No.: US 2019/0064920 A1
(43) Pub. Date: Feb. 28, 2019

(54) CONTROLLING AND CONFIGURING UNIT AND METHOD FOR CONTROLLING AND CONFIGURING A MICROSCOPE

(71) Applicant: CARL ZEISS MICROSCOPY GMBH, Jena (DE)

(72) Inventors: Alexander GAIDUK, Jena (DE); Ralf WOLLESCHENSKY, Jena (DE); Pavlos ILIOPOULOS, Weimar (DE)

(21) Appl. No.: 16/084,250

(22) PCT Filed: Apr. 6, 2017
(86) PCT No.: PCT/EP2017/058188

§ 371 Date: Sep. 12, 2018

(30) Foreign Application Priority Data
Apr. 15, 2016 (DE) 10 2016 106 993.0

(51) Int. Cl. G06F 3/01; G06T 19/00; G02B 27/01

(52) U.S. Cl. CPC G06F 3/011; G06F 3/016; G02B 27/0172; G06T 19/006; G06F 3/017

(57) ABSTRACT

The present invention relates firstly to a method for controlling and/or configuring a microscope. One step of the method involves generating a virtual reality in which at least synthetic control elements for controlling the microscope and components of the microscope are displayed. In another step, user inputs performed by an operator of the microscope in the virtual reality in relation to the displayed control elements and/or the depicted components of the microscope are detected. According to the invention, the user inputs are used to control and/or configure the microscope. The invention further relates to a control and/or configuration unit for a microscope.

### FIELD

The present invention relates firstly to a method for controlling and/or configuring a microscope. The method can consist, for example, of a workflow for controlling and/or configuring the microscope in a mixed reality. The invention further relates to a control and/or configuration unit for a microscope.

### BACKGROUND

US 2010/0248200 A1 discloses a system for generating a virtual reality for educational applications in medicine.

US 2013/0125027 A1 teaches a system for generating a virtual reality in which a plurality of remote participants can act.

A method for generating a virtual reality is known from US 2013/0036371 A1 in which virtual and real views are superimposed.

U.S. Pat. No. 8,621,368 B2 discloses a method for interacting in a virtual reality.

A method for linking a real and a virtual world is known from US 2012/0188256 A1 in which virtual objects are controlled in the virtual world.

US 2015/0118987 A1 teaches a method for selecting network resources using character strings to initialize communication with the respective network resource.

US 2015/0016777 A1 discloses a planar waveguide that enables multiple optical beam paths and can be used for head-mounted displays, for example.

In the scientific article by Dombeck, Daniel A. et al.: “Functional imaging of hippocampal place cells at cellular resolution during virtual navigation” in Nature Neuroscience 13, pages 1433-1440 (2010), a method for visualizing the activity of nerve cells in the hippocampus is described.

At the annual conference of the Society for Neuroscience annual meeting on 25 Sep. 2015 in Chicago, USA, Carl Zeiss Microscopy GmbH presented a three-dimensional visualization of previously recorded and post-processed micrographs using a virtual reality headset.

The product sheet of Carl Zeiss Microscopy GmbH, “Zeiss Axio Scan.Z1,” dated July 2013, describes a device for the virtual microscopy of virtual slides. The device is a scanner with which real specimens can be digitized in very high resolution. The resulting large amounts of data are available for later analysis, visualization, and evaluation. The data can be accessed via the internet.

The computer game “Disassembly 3D” simulates the disassembly of various objects. Screws, bolts, nuts, and other parts can be removed with one's bare hands. The object to be disassembled is a microscope, for example.

A multifunctional control unit for an optical microscope is known from DE 196 37 756 A1 that can be held in a single hand and preferably has the shape of a computer mouse.

DE 20 2009 017 670 U1 shows a microscope control unit with manually operable roller-shaped control elements for the x/y adjustment of an XY stage and optionally the z adjustment of the focusing device of the microscope.

The prior art uses special consoles and mouses as well as touchable displays to control microscopes. These controllers are equipped in part with adjustment wheels.

US 2015/0032414 A1 describes a method for the three-dimensional measurement of a specimen using a laser scanning microscope. A control device is used, among other things, for physically controlling the specimen as well as the laser. A virtual reality is used to represent the microimaged specimen. The operator can select and change the views of the specimen within the virtual reality, for which purpose a 3D input device is made available. The operator can select a virtual configuration of the microscope to which the real configuration of the microscope is adapted.

DE 601 30 264 T2 discloses a method for controlling a microscope during a surgical procedure using an augmented reality.

US 2015/0085095 A1 describes a system for surgical visualization having physical and virtual user interfaces.

US 2014/0088941 A1 teaches a system for simulating surgical procedures in which a virtual reality is created with haptic augmentation.

In taking the prior art as a point of departure, it is the object of the present invention to facilitate the complex operation, controlling, and/or configuration of microscopes. It is also intended to facilitate the learning of the technical function of microscopes, particularly of their hardware, and of workflows when operating the microscope. The development and prototyping of microscopes is also to be facilitated as a result.

### SUMMARY

This object is achieved by a method according to the enclosed claim 1 as well as by a control and/or configuration unit according to enclosed subsidiary claim 15.

The method according to the invention serves the purpose of controlling and/or configuring a microscope and thus constitutes a method for operating, controlling, and/or configuring the microscope. The microscope is preferably a real microscope or, as a preferred alternative, a virtual microscope. The virtual microscope is synthetic and instantiated by software in a computer. The physical, real microscope is preferably a digital microscope in which an electronic image conversion takes place, with the recorded image being further processed in the form of digital data and displayed on an electronic image display device. However, the physical real microscope can also be a microscope of another type or based on a different functional principle.

The inventive method comprises a step in which a virtual reality is generated and displayed. The virtual reality is displayed visually and preferably also acoustically. The virtual reality is three-dimensional and is preferably displayed in three dimensions as well. Control elements for controlling the microscope are shown in this virtual reality, with the control elements comprising at least synthetic control elements. The illustrated control elements represent possible settings or choices for parameters and/or functions of the microscope. In addition, at least components of the microscope are represented in this virtual reality. The components of the microscope are, in particular, assemblies or functional units of the microscope.

In another step of the method, user inputs performed by an operator of the microscope in the virtual reality in relation to the displayed control elements and/or the depicted components of the microscope are detected. The user inputs can be detected optically, acoustically, haptically, mechanically, or electromagnetically, for example. The user inputs can be detected using image recognition and/or speech recognition methods, for example. The user inputs can be inputted by means of a gesture, for example, or by touching or changing an object.

In another step of the method, the user inputs are used for controlling, for operating, and/or for configuring the microscope, so that the microscope is operated and/or configured according to the user inputs that are performed in the virtual reality. Configuration comprises, in particular, the joining-together and/or separation of components of the microscope, i.e., the assembly or disassembly of the microscope.

One particular advantage of the method according to the invention is that it utilizes the enhanced possibilities of virtual reality to assist the operator or developer of a microscope. This can save costs for the briefing of the operator or for prototypes. The method can also be used in the development of microscopes in order to achieve optimal operation of the microscope. The method can also be used for training purposes or to administer tests on microscopes. Such training or tests can be carried out in many fields of application on the basis of different images that were made previously of real specimens using real microscopes.

In preferred embodiments of the method according to the invention, the virtual reality is generated and displayed as an augmented reality or as a mixed reality. In the augmented or mixed reality, real control elements of the microscope and real components of the microscope are also displayed in addition to the synthetic control elements. In order to represent the real control elements of the real microscope, control elements present on the real microscope are reproduced in the augmented or mixed reality. In order to represent the components of the real microscope, components that are present on the real microscope are reproduced in the augmented or mixed reality. The representation of the synthetic control elements is generated synthetically, particularly in a computer. The components of the virtual microscope are generated synthetically, particularly in a computer. The augmented or mixed reality is characterized in that, in addition to synthetic elements, natural elements are also displayed or reproduced. The synthetic elements and the natural elements are represented or reproduced together in the augmented or mixed reality.

In preferred alternative embodiments of the method according to the invention, only virtual content is represented in the virtual reality, so that the control elements are likewise completely constituted by the synthetic control elements.

The method can consist, for example, of a workflow for controlling and/or configuring the microscope in a mixed reality. The microscope is thus located neither exclusively in the real world nor exclusively in the virtual world. The operator can perceive the microscope that is located in the mixed reality within the real world, in which case all of the limitations of the real world apply. This makes it easier to learn to use and operate the microscope with different equipment and configurations, for example. There is preferably data communication with the real microscope, so that the images of the specimen that are taken using the real microscope can be transferred to the representations of the microscope and also displayed, for example. In addition, data communication preferably takes place for the purpose of transmitting analytical data. Data communication preferably occurs with terminals of several operators, who can share the images of the specimen and/or the analytical data.

In preferred embodiments of the method according to the invention, the real microscope is represented with the synthetic control elements in the virtual reality, in which case the synthetic control elements in the representation preferably replace real control components of the microscope. The synthetic control elements preferably replace a real control unit of the microscope in the representation. For example, a real control unit that is complicated to operate and requires appropriate expertise can be replaced in the presentation with simple synthetic control elements that require little or no expertise to operate. The synthetic control elements are preferably not displayed simultaneously, but rather as a function of an operating sequence, as a function of an interactive guidance sequence, and/or as a function of a usage state and/or a set state and/or a configuration state of the microscope. In this embodiment, the microscope is much easier to operate within the augmented reality. The simple synthetic control elements are preferably instantiated by a switching element for turning the microscope on and off, a shutter release for taking an overview image, a shutter release for taking a microscopic image, a shutter release for taking a high-contrast image, a control element for moving a microscope stage of the microscope, a control element for initiating a coarse autofocus adjustment, a control element for initiating a fine autofocus adjustment, and/or a control element for initiating the outputting of a report.

In preferred embodiments of the method according to the invention, the entire microscope is shown, particularly the entire real microscope and/or the entire virtual microscope.

In preferred embodiments of the method according to the invention, images of a real specimen taken with the microscope, with another microscope, or with different microscopes are displayed together with the microscope and the virtual reality control elements. Alternatively or in addition, real control elements can be displayed. In this way, the microscope or a workflow when operating the microscope can be simulated in order to gain experience with the microscope. This enables cost- and time-efficient studying of the microscope, including its equipment and applications. It also enables efficient development of the microscope, including its hardware and software and service features.

In another preferred embodiment, the specimen is not merely displayed visually, for which purpose the specimen is additionally rendered tactile, so that the operator can perceive a microscopic reproduction of the specimen tactilely and haptically. The operator can thus perceive the specimen tactilely and haptically in an enlarged form, particularly by feel using his fingers and/or hand. Microscopic specimens that are not perceptible to the human eye or to the human sense of touch can be perceived in this embodiment of the invention both visually as well as tactilely and haptically. The tactile rendering of the specimen preferably corresponds spatially to the visual microscopic representation of the specimen, meaning that the operator's visual perception and their tactile and/or haptic perception basically match, thus enabling a high degree of immersion. The operator can also perceive the enlarged visual representation of the specimen tactilely and haptically, thereby enabling the operator to feel a visually enlarged portion of the specimen. The tactile reproduction is preferably carried out on a playback stage having technical means for tactile reproduction, with the visual representation preferably also taking place on this stage. The tactile reproduction of the specimen preferably corresponds spatially and temporally to the visual representation of the specimen. The tactile reproduction of the specimen involves rendering the topology of the specimen, particularly the enlarged reproduction of the topology of the specimen. The tactile reproduction of the specimen preferably also includes the reproduction of physical and/or chemical properties of the surface of the specimen. The physical properties preferably include surface strength, surface friction properties, body color of the surface, roughness of the surface, softness of the surface, and/or temperature of the surface of the specimen. The operator can thus tactually and/or haptically perceive different properties of the specimen by feeling the reproduction of the specimen. For example, the operator can slide a finger on the tactile reproduction within the virtual reality, thereby haptically perceiving not only the topology of the specimen, but also other surface properties of the specimen. The tactile reproduction of the specimen is preferably interactive, so that haptic user inputs are recorded simultaneously.

In order to generate and three-dimensionally represent the virtual reality or the augmented reality, a three-dimensional display, more preferably a pair of virtual reality glasses, augmented reality glasses, or mixed reality glasses is preferably used, which the operator wears on his head in front of his eyes. However, other head-mounted displays or a projection, such as in a CAVE, can be used. In a simple case, one or more two-dimensional displays can also be used. In other preferred embodiments, a virtual reality headset, an augmented reality headset, or a mixed reality headset is used to generate and three-dimensionally represent the virtual reality or the augmented reality.

The generation and the three-dimensional representation of the virtual reality or the augmented reality are preferably performed in spatial dependence on a position of the operator. Alternatively or in addition, the generation and the three-dimensional representation of the virtual reality or the augmented reality are preferably performed in spatial dependence on a position of the microscope.

In preferred embodiments of the method according to the invention, components of the microscope or the entire microscope are displayed in virtual reality or in augmented reality in addition to the control elements.

In preferred embodiments of the method according to the invention, microscope images that were captured using the microscope are also displayed in the virtual reality or in the augmented reality in addition to the control elements. The microscope images are displayed in order to facilitate or enable the operator to execute controls.

In especially preferred embodiments of the method according to the invention, help information is also displayed in the virtual reality or in the augmented reality. The help information provides the operator with assistance in controlling the microscope. The help information is preferably displayed independently of a position and viewing direction of the operator. The help information preferably includes text, error messages, symbols such as arrow symbols, warnings, instructional videos, and/or a helping avatar. The help information preferably also includes acoustic help information, for example in the form of natural or synthetic speech.

In especially preferred embodiments of the method according to the invention, the operator is interactively guided in the virtual reality or in the augmented reality in order to teach and/or facilitate the controlling and/or the operation and/or the configuration of the microscope. In this respect, e-learning is performed within the method according to the invention. The interactive guidance guides the operator in controlling, operating, or configuring the microscope.

Within the interactive guidance, microscope images are preferably displayed in virtual reality or in augmented reality in order to assist in guiding the operator. These microscope images were preferably taken with the microscope.

The control elements and/or the components of the microscope are preferably displayed within the interactive guide as a function of an interactive guidance sequence, meaning that they are not displayed statically. The individual control elements and/or the individual components of the microscope are thus represented, not represented, or represented in altered form as a function of a state of the temporally changing interactive guidance and/or as a function of user input by the operator.

The control elements and/or the components of the microscope are preferably displayed as a function of a usage state and/or as a function of a set state and/or as a function of a configuration state of the microscope. The individual control elements and/or the individual components of the microscope are thus not displayed or they are displayed in altered form as a function of the state of use and/or set state of the microscope, which change over time, and/or as a function of the changing configuration state. Accordingly, fade-in and/or fade-out of the control elements or fade-in and/or fade-out of the individual components of the microscope preferably occurs as a function of the state of use and/or depending on the set state and/or depending on the configuration state of the microscope.

The configuring of the microscope preferably includes the joining-together and/or separation of components of the microscope, i.e., the assembly or disassembly of the microscope. Preferably, at least one physical microscope baseplate is used to configure the microscope displaying in virtual reality. The virtual reality components of the microscope can be virtually arranged on the real microscope baseplate. There are preferably markers on the microscope baseplate that show the operator where to place the displayed components of the microscope. The microscope baseplate preferably has certain surface properties, such as locally varying roughness, that facilitate orientation for the operator.

The user inputs are preferably constituted by gestures of the operator. One of the gestures preferably consists in the operator pointing with his finger or hand. This gesture preferably has the effect that the region of the enlarged specimen to which the operator is pointing is marked or enlarged again. Another of the gestures preferably consists in the operator moving his finger or hand along a circular path. This gesture preferably has the effect of the enlarged representation of the specimen being rotated. Another of the gestures preferably consists in the operator walking forward or backward with respect to the representation of the specimen. This gesture preferably has the effect that the magnification and/or the resolution of the representation of the specimen is increased or decreased.

In especially preferred embodiments of the method according to the invention, the user inputs are performed using a real action object. The real action object is used by the operator to perform the user input. The real action object can be regarded as a totem. A shape, a color, a pattern and/or a movement of the action object can be used to encode information to be transmitted with the user input. The action object can be instantiated by a passive object or by an active object. Preferably, the action object is a glove having a marker and, as such, is passive. The operator can be recognized by the glove on his hand, and a movement of the glove can represent a user input. In other preferred embodiments, the action object is a 3D mouse, a data glove, or a flystick. Such active action objects represent input devices and are established in virtual reality and augmented reality applications. The operator can enter user information by means of the 3D mouse, data glove, or flystick.

In preferred embodiments of the method according to the invention, the control elements comprise at least one control element for switching the microscope on and off, and preferably at least one control element for interrupting the operation of the microscope.

In preferred embodiments of the method according to the invention, the control elements comprise one or more control elements for setting a microscope illumination of the microscope. The control elements for adjusting the microscope illumination of the microscope preferably comprise at least one control element for switching the microscope illumination on and off, at least one control element for selecting parameters of the microscope illumination, at least one control element for selecting a mode of microscope illumination, and/or at least one control element for selecting a source of the microscope illumination.

In preferred embodiments of the method according to the invention, the control elements comprise one or more control elements for setting acquisition parameters or exposure parameters of the microscope. The control elements for setting the acquisition parameters or the exposure parameters preferably comprise at least one control element for setting a acquisition time or exposure time, at least one control element for setting an acquisition correction, at least one control element for selecting an automatic acquisition or an automatic exposure, at least one control element for setting an acquisition rate, at least one control element for setting an acquisition quality and/or at least one control element for setting an acquisition mode.

In preferred embodiments of the method according to the invention, the control elements comprise one or more control elements for controlling an acquisition process and/or an illumination process of the microscope. The control elements for controlling the acquisition process or the exposure process preferably comprise at least one control element for starting the acquisition process or the exposure process, at least one control element for terminating the acquisition process or the exposure process, at least one control element for interrupting the acquisition process or the exposure process, at least one control element for capturing a frame, at least one control element for capturing an image sequence and/or at least one control element for capturing a frame sequence.

In preferred embodiments of the method according to the invention, the control elements comprise one or more control elements for moving a microscope stage of the microscope. The control elements for moving the microscope stage preferably comprise at least one control element for setting an x, y, or z position of the microscope stage and/or at least one control element for setting a rotation and/or an inclination of the microscope stage.

In preferred embodiments of the method according to the invention, the control elements comprise one or more control elements for setting microimaging parameters of the microscope. The control elements for adjusting the microimaging parameters of the microscope preferably comprise at least one control element for setting a contrast and/or at least one control element for selecting microimaging options.

In preferred embodiments of the method according to the invention, the control elements comprise at least one control element for navigating in two-dimensional microscope images, at least one control element for navigating in three-dimensional microscope images, and/or at least one control element for switching between two-dimensional microscope images and three-dimensional microscope images.

In preferred embodiments of the method according to the invention, the control elements comprise at least one control element for temporal navigation within an image sequence and/or at least one control element for temporal navigation within a frame sequence.

In preferred embodiments of the method according to the invention, the control elements comprise at least one control element for crossfading two two-dimensional microscope images and/or at least one control element for displaying correlations between two crossfaded two-dimensional microscope images.

In preferred embodiments of the method according to the invention, the control elements comprise at least one control element for crossfading two three-dimensional microscope images and/or at least one control element for displaying correlations between two crossfaded three-dimensional microscope images.

In preferred embodiments of the method according to the invention, the control elements comprise at least one control element for navigating in an archive of microscope images and/or at least one control element for storing microscope images.

In preferred embodiments of the method according to the invention, the control elements comprise at least one control element for connecting an external device to the microscope.

In preferred embodiments of the method according to the invention, the control elements comprise at least one control element for updating software of the microscope.

In virtual reality or augmented reality, the operator receives visual feedback, particularly visual feedback on his user input or with respect to interactive guidance. Preferred embodiments of the method according to the invention further comprise a step in which at least one acoustic feedback is given to the operator, particularly while the operator is performing user inputs in the virtual reality or during the interactive guidance. A speaker or a headphone is used for this purpose. Other preferred embodiments of the method according to the invention further comprise a step in which at least one haptic feedback is given to the operator, particularly while the operator is performing user inputs in the virtual reality or during the interactive guidance. A suitably equipped data glove is used for this purpose, for example. The haptic feedback is preferably directed at a hand of the operator. The haptic feedback preferably includes active force feedback, also referred to as force feedback. The operator thus receives a force as feedback.

The visual feedback, the acoustic feedback, and/or the haptic feedback is preferably dependent on a status of the microscope, on a status of a component of the microscope, and/or on a status of a process in the microscope.

The visual feedback, the acoustic feedback, and/or the haptic feedback, but particularly the haptic feedback is preferably given by the action object to the operator. The action object is preferably a haptic feedback-capable 3D mouse, a haptic feedback-capable data glove, or a haptic feedback-capable flystick.

The control and/or configuration unit according to the invention is provided for a microscope and serves the purpose of controlling and/or configuring the microscope. The control and/or configuration unit according to the invention comprises a display for generating and displaying a virtual reality. Control elements for controlling the microscope and components of the microscope can be displayed in this virtual reality, with the control elements comprising at least synthetic control elements. The displayable control elements represent parameters and/or functions of the microscope. The display is preferably a three-dimensional display. The three-dimensional display is preferably embodied as virtual reality glasses, augmented reality glasses or mixed-reality glasses that the operator carries on his head in front of his eyes. However, the display can also be embodied as another head-mounted display or projectors, e.g., in a CAVE. In a simple case, the display can be a two-dimensional display. However, the display can also preferably be embodied as a virtual reality headset, an augmented reality headset, or a mixed reality headset.

The control and/or configuration unit according to the invention further comprises at least one input device for detecting user inputs performed by an operator of the microscope in the virtual reality in relation to the displayed control elements and/or the depicted components of the microscope. The at least one input device is preferably instantiated by an optical sensor that recognizes the operator and gestures of the operator. The at least one input device is preferably instantiated by a location and/or position sensor that is arranged on the operator. The at least one input device is preferably instantiated by a computer input device, particularly by a 3D mouse, a data glove, or a flystick. The at least one input device preferably comprises active force feedback.

The control and/or configuration unit according to the invention further comprises control and/or configuration electronics for controlling and/or configuring the microscope in accordance with the user inputs that are performed. The control and/or configuration electronics are preferably instantiated by a computer or computing device.

The control and/or configuration unit according to the invention is preferably configured to carry out the method according to the invention. The control and/or configuration unit according to the invention is preferably configured to carry out one of the described preferred embodiments of the method according to the invention. Moreover, the control and/or configuration unit according to the invention preferably also has the features that are specified in connection with the method according to the invention and its preferred embodiments.

### BREIF DESCRIPTION OF THE DRAWINGS

Additional details and developments of the invention follow from the following description of preferred exemplary embodiments of the invention with reference to the drawing.

FIG. 1 illustrates two preferred embodiments of the invention. In embodiment I, a real microscope (R) is used to receive a real specimen (R). According to the invention, the controlling and/or configuration of the real microscope are performed by means of user inputs in a virtual reality (V). In embodiment II, a virtual microscope (V) is used to acquire a virtual specimen (V), which is performed in a computer. According to the invention, the virtual microscope is controlled and/or configured by means of user inputs in an augmented reality (V/R).

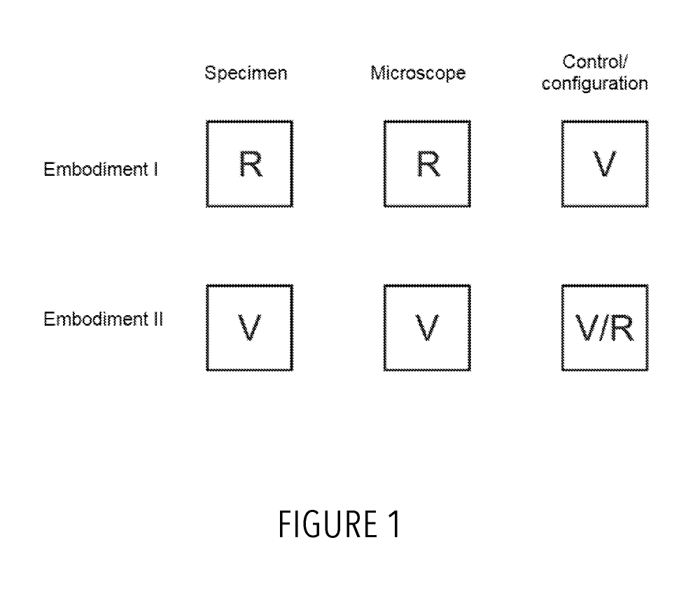

### DETAILED DESCRIPTION

A preferred operating sequence of the method according to the invention is described below by way of example. A specimen to be microimaged is displayed in an augmented reality. A hand of an operator who is holding the specimen to be microimaged is also displayed, for example. The specimen to be microimaged is then enlarged in augmented reality. Within the augmented reality, the operator can point with his real hand or fingers to a region of the enlarged representation of interest to him, which, for example, results in this region being marked or enlarged again. Furthermore, the operator can rotate the enlarged representation of the specimen by means of a gesture with his real finger along a largely arbitrary circular path, whereby he can cause the area of interest to him to be displayed. Furthermore, markers are displayed on the enlarged representation of the specimen in augmented reality. The markers are embodied as letters, for example. If the magnified representation of the specimen is rotated in augmented reality, the representations of the markers are also rotated. The markers then represent different perspectives. The movement of the operator in the augmented reality constitutes a user input. If the operator moves forward, the magnification or the resolution of the representation of the specimen increases. If the operator moves backward, the magnification or the resolution of the representation of the specimen is reduced.

1. A method for controlling and/or configuring a microscope, comprising the following steps:
generating a virtual reality in which at least synthetic control elements for controlling the microscope and components of the microscope are displayed;
detecting user inputs performed by an operator of the microscope in the virtual reality in relation to the displayed control elements and/or the depicted components of the microscope; and
using the user inputs to control and/or configure the microscope.

2. The method as set forth in claim 1, wherein the virtual reality is generated as an augmented reality in which, in addition to the synthetic control elements, real control elements and real components of the microscope are also displayed.

3. The method as set forth in claim 1, wherein images of a real specimen are displayed together with the represented components of the microscope and the control elements in the virtual reality.

4. The method as set forth in claim 3, wherein the specimen is further rendered tactile, so that the operator can tactilely and haptically perceive a microscopic reproduction of the specimen.

5. The method as set forth in claim 1, wherein virtual reality glasses, augmented reality glasses, mixed-reality glasses, a virtual reality headset, an augmented reality headset, or a mixed-reality headset is used to generate the virtual reality.

6. The method as set forth in claim 1, wherein the generating and displaying of the virtual reality take place in a spatial dependence on a position of the operator.

7. The method as set forth in claim 1, wherein help information continues to be displayed in the virtual reality that-is composed of text, error messages, warnings, instructional videos, a helping avatar, and/or interactive guidance of the operator.

8. The method as set forth in claim 7, wherein the help information is displayed independently of a position and viewing direction of the operator.

9. The method as set forth in claim 1, wherein microscope images of the microscope continue to be displayed in the virtual reality.

10. The method as set forth in claim 1, wherein the control elements and/or components of the microscope are represented as a function of an interactive guidance sequence and/or as a function of a use state and/or of a set state and/or of a configuration state of the microscope.

11. The method as set forth in claim 1, wherein the user inputs are performed using a real action object.

12. The method as set forth in claim 11, wherein the action object is a passive glove, a 3D mouse, a data glove, or a flystick that is provided with a marker.

13. The method as set forth in claim 1, wherein the control elements comprise one or more control elements for switching the microscope on and off, one or more control elements for adjusting a microscope illumination of the microscope, one or more control elements for adjusting acquisition parameters of the microscope, one or more control elements for controlling an acquisition process of the microscope, one or more control elements for moving a microscope stage of the microscope, one or more control elements for navigating microscope images of the microscope, one or more control elements for temporal navigation within an image sequence or within a frame sequence of the microscope, and/or one or more control elements for crossfading two microscope images of the microscope.

14. The method as set forth in claim 1, further comprising a step in which haptic feedback is given to the operator while the operator performs the user inputs in the virtual reality.

15. A control and/or configuration unit for a microscope, comprising:
a display for generating a virtual reality in which at least synthetic control elements for controlling the microscope and components of the microscope can be displayed;
at least one input device for detecting user inputs performed by an operator of the microscope in the virtual reality in relation to the displayed control elements and/or the depicted components of the microscope; and
control and/or configuration electronics for controlling and/or configuring the microscope in accordance with the user inputs.

16. The method as set forth in claim 2 wherein images of a real specimen are displayed together with the represented components of the microscope and the control elements in the virtual reality.

17. The method as set forth in claim 2 wherein virtual reality glasses, augmented reality glasses, mixed-reality glasses, a virtual reality headset, an augmented reality headset, or a mixed-reality headset is used to generate the virtual reality.

18. The method as set forth in claim 2 wherein the generating and displaying of the virtual reality take place in a spatial dependence on a position of the operator.

19. The method as set forth in claim 2 wherein microscope images of the microscope continue to be displayed in the virtual reality.

20. The method as set forth in claim 11 further comprising a step in which haptic feedback is given to the operator while the operator performs the user inputs in the virtual reality.
